(19) United States
(12) Patent Application Publication
(10) Pub. No.: US 2024/0113307 A1
(43) Pub. Date: Apr. 4, 2024

(54) CURRENT COLLECTOR AND BATTERY

(71) Applicant: Panasonic Intellectual Property Management Co., Ltd., Osaka (JP)

(72) Inventors: AKIO KANEYAMA, Osaka (JP); KOICHI HIRANO, Osaka (JP)

(21) Appl. No.: 18/540,976

(22) Filed: Dec. 15, 2023

Related U.S. Application Data
(63) Continuation of application No. PCT/JP2022/019224, filed on Apr. 28, 2022.

(30) Foreign Application Priority Data
Jul. 12, 2021 (JP) 2021-114869

(51) Int. Cl. H01M 4/66; H01M 10/052

(52) U.S. Cl. CPC H01M 4/667; H01M 4/661; H01M 10/052; H01M 2004/021

(57) ABSTRACT

A current collector including a first metal layer that contains a first metal, a conductor layer that contains a conductive carbon material, a second metal layer that contains a second metal, and a third metal layer that contains a third metal different from the first metal and the second metal, in which the first metal layer, the conductor layer, the second metal layer, and the third metal layer are laminated in this order, and the third metal is nickel or copper.

### BACKGROUND

### 1. Technical Field

The present disclosure relates to a current collector and a battery formed of the current collector.

### 2. Description of the Related Art

In recent years, secondary batteries containing solid electrolytes such as all-solid-state batteries have been actively examined and developed for applications in mobile devices, hybrid vehicles, electric vehicles, and storage batteries for domestic use. Such batteries are required to have a higher energy density. Further, such batteries include batteries formed of current collectors using, as a base material, a metal foil made of aluminum. Examples of the batteries formed of current collectors include a lithium secondary battery formed of a positive electrode plate in which a positive electrode layer containing a lithium compound on such a metal foil.

Japanese Unexamined Patent Application Publication No. 2020-262866 discloses a current collector obtained by forming a metal layer and a non-metal conductor layer on aluminum foil in order to improve corrosion resistance.

WO2012/115050A1 discloses a current collector formed of a plurality of conductive layers in order to improve properties of a capacitor.

Japanese Unexamined Patent Application Publication No. 2009-4363 discloses a structure obtained by laminating a plurality of metal layers for the purpose of improving adhesiveness to a positive electrode mixture.

Japanese Unexamined Patent Application Publication No. 2017-10782 discloses a current collector provided with a lithium barrier layer in order to improve safety.

### SUMMARY

In the related art, a battery that suppresses degradation of battery properties and has a high energy density has been required. One non-limiting and exemplary embodiment provides a current collector and a battery that are capable of achieving both improvement of the energy density of the battery and suppression of degradation of the battery properties.

In one general aspect, the techniques disclosed here feature a current collector including a first metal layer that contains a first metal, a conductor layer that contains a conductive carbon material, a second metal layer that contains a second metal, and a third metal layer that contains a third metal different from the first metal and the second metal, in which the first metal layer, the conductor layer, the second metal layer, and the third metal layer are laminated in this order, and the third metal is nickel or copper.

According to the present disclosure, it is possible to achieve both improvement of the energy density of the battery and suppression of degradation of battery properties.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing a schematic configuration of a current collector according to Embodiment 1;

FIG. 2 is a cross-sectional view showing a schematic configuration of a battery according to Embodiment 2; and

FIG. 3 is a cross-sectional view showing a schematic configuration of another battery according to Embodiment 2.

### DETAILED DESCRIPTIONS

### (Underlying Knowledge Forming Basis of the Present Disclosure)

A battery containing a solid electrolyte such as an all-solid-state battery typically includes a power generation element including a positive electrode layer, a solid electrolyte layer, and a negative electrode layer. The battery can function as a battery when the battery includes at least one power generation element, but the voltage of the battery can be increased by laminating a plurality of power generation elements such that the power generation elements are electrically connected to each other in series. Further, when a plurality of power generation elements are laminated, since the power generation elements are electrically connected to each other via current collectors such as a metal foil provided on the positive electrode layer and the negative electrode layer of each power generation element as compared with a case where the battery includes a single power generation element, the battery properties can be degraded due to an increase in contact resistance between the current collector provided on the positive electrode layer and the current collector provided on the negative electrode layer. Further, the contact resistance can be improved by increasing the confining pressure on the battery during charging and discharging, but the size of a jig for increasing the confining pressure is typically increased, and as a result, the energy density of the entire battery is decreased. Further, two current collectors, which are the current collector provided on the positive electrode layer and the current collector provided on the negative electrode layer, are laminated between the power generation elements, and thus the thickness of the battery is increased and the energy density of the battery is decreased.

Further, when any one of the current collector provided on the positive electrode layer or the current collector provided on the negative electrode layer is shared by adjacent power generation elements, that is, when one current collector is disposed between adjacent power generation elements, the contact resistance is eliminated, and the energy density can be improved. However, the current collector is alloyed with lithium at any action potential of the positive electrode layer or the negative electrode layer and embrittled, and/or the current collector material is eluted into any of the positive electrode layer or the negative electrode layer and is thus deteriorated. Therefore, the battery properties may be degraded. For example, aluminum is likely to be deteriorated when used in the current collector for a negative electrode layer, and nickel and copper are likely to be deteriorated when used in the current collector for a positive electrode layer. Further, the electric resistance of a metal or an alloy that is unlikely to be alloyed with lithium and unlikely to be eluted at the action potential of both the positive electrode layer and the negative electrode layer tends to increase, and the battery properties are degraded when such a metal or an alloy is used in the current collector.

The present disclosure has been made based on the above-described knowledge, both the improvement of the energy density of a battery and suppression of degradation of the battery properties can be achieved by a current collector that can be thinned while the degradation of the battery properties is suppressed by suppressing an increase in resistance between the power generation elements and deterioration of the current collector.

The outline of one aspect according to the present disclosure is as follows.

According to one aspect of the present disclosure, there is provided a current collector including: a first metal layer that contains a first metal; a conductor layer that contains a conductive carbon material; a second metal layer that contains a second metal; and a third metal layer that contains a third metal different from the first metal and the second metal, in which the first metal layer, the conductor layer, the second metal layer, and the third metal layer are laminated in this order, and the third metal is nickel or copper.

In this manner, the current collector is unlikely to deteriorate even when the power generation elements are electrically connected in series by bonding the positive electrode layer to the first metal layer and bonding the negative electrode layer to the third metal layer using the current collector according to the present aspect. Specifically, since the first metal layer contains the first metal different from the third metal which is nickel or copper, deterioration such as lithium alloying is unlikely occur even when the first metal layer is bonded to the positive electrode layer. Further, since the third metal layer contains the third metal which is nickel or copper, deterioration such as lithium alloying is unlikely to occur even when the third metal layer is bonded to the negative electrode layer. Further, since the second metal layer and the third metal layer containing metals different from each other are laminated, both the suitability of the bonding to the negative electrode layer and the mechanical strength can be achieved by appropriately selecting the second metal and the third metal. Further, the conductor layer is positioned between the first metal layer and the second metal layer, and thus the binding properties of the first metal layer and the second metal layer are improved and the battery properties are unlikely to be degraded. In addition, since the power generation elements can be electrically connected without disposing two current collectors between the power generation elements, the energy density of the battery can be increased. Therefore, both improvement of the energy density of the battery and suppression of degradation of the battery properties can be achieved by using the current collector according to the present aspect.

Further, for example, the first metal may be aluminum or iron.

In this manner, lithium alloying and elution into the positive electrode layer are unlikely to occur in the first metal layer when the first metal layer is bonded to the positive electrode layer, and thus degradation of the battery properties can be suppressed.

Further, for example, the second metal may be titanium or chromium.

In this manner, the second metal layer with high hardness is likely to be formed, and it is possible to suppress the negative electrode layer to be bonded to the third metal layer from coming into contact with the first metal layer by pressurization or the like during the production of the battery.

Further, for example, the second metal layer may be harder than the third metal layer.

In this manner, the negative electrode layer to be bonded to the third metal layer can be suppressed from coming into contact with the first metal layer by pressurization or the like during the production of the battery. Further, since a third metal layer to be bonded to the negative electrode layer is softer than the negative electrode layer, the contact resistance between the negative electrode layer and the third metal layer is unlikely to increase.

Further, for example, a total thickness of the second metal layer and the third metal layer may be less than a thickness of the first metal layer.

In this manner, the energy density of the battery formed of the current collector can be improved.

Further, for example, a thickness of the third metal layer may be greater than a thickness of the second metal layer.

In this manner, since the thickness of the third metal layer containing copper or nickel is increased, the electric resistance of the current collector is unlikely to be increased, and degradation of the battery properties of the battery formed of the current collector can be suppressed.

Further, for example, a thickness of the first metal layer is greater than or equal to 3 μm and less than or equal to 50 μm.

In this manner, both the improvement of the mechanical strength of the current collector and the improvement of the energy density of the battery formed of the current collector can be achieved.

Further, for example, a thickness of the second metal layer may be greater than or equal to 0.1 μm and less than or equal to 0.5 μm.

In this manner, the second metal layer is unlikely to be peeled off. Further, the negative electrode layer to be bonded to the third metal layer can be suppressed from coming into contact with the first metal layer by pressurization or the like during the production of the battery.

Further, for example, a thickness of the third metal layer may be greater than or equal to 0.5 μm and less than or equal to 1.5 μm.

In this manner, the third metal layer is unlikely to be peeled off. Further, the negative electrode layer to be bonded to the third metal layer can be suppressed from coming into contact with the first metal layer by pressurization or the like during the production of the battery.

Further, for example, a thickness of the conductor layer may be greater than or equal to 0.1 μm and less than or equal to 2.0 μm.

In this manner, both the improvement of the binding properties between the first metal layer and the second metal layer and the improvement of the energy density of the battery formed of the current collector can be achieved.

Further, according to one aspect of the present disclosure, there is provided a battery including: the current collector described above; and at least one power generation element that includes a positive electrode layer, a negative electrode layer disposed to face the positive electrode layer, and a solid electrolyte layer positioned between the positive electrode layer and the negative electrode layer, in which the at least one power generation element includes a first power generation element to be laminated adjacent to the current collector, and the first metal layer of the current collector faces the positive electrode layer of the first power generation element without sandwiching the solid electrolyte layer of the first power generation element and the conductor layer of the current collector.

In this manner, a battery in which the first metal layer of the current collector is electrically connected to the positive electrode layer of the first power generation element can be realized. Further, the first metal layer is laminated on the positive electrode layer without sandwiching other layers, but contains the first metal different from the third metal which is nickel or copper, and thus deterioration is unlikely to occur. Therefore, degradation of the battery properties of the battery formed of the current collector can be suppressed. Further, since the third metal layer on a side of the current collector opposite to the first metal layer contains the third metal which is nickel or copper, the third metal layer is unlikely to deteriorate even when bonded to the negative electrode layer. Accordingly, in the battery according to the present aspect, the battery properties are unlikely to be degraded even when the third metal layer is bonded to the negative electrode layer of a power generation element different from the first power generation element without sandwiching other current collectors so that the power generation element and another power generation element are electrically connected in series. Therefore, the energy density can be increased by decreasing the number of current collectors to be used.

Further, for example, the at least one power generation element may further include a second power generation element to be laminated adjacent to the first power generation element via the current collector, and the third metal layer of the current collector may face the negative electrode layer of the second power generation element without sandwiching the solid electrolyte layer of the second power generation element and the second metal layer of the current collector.

In this manner, a battery with a high voltage in which the first power generation element and the second power generation element are electrically connected in series can be realized using one current collector by electrically connecting the third metal layer of the current collector to the negative electrode layer of the second power generation element. Therefore, the energy density of the battery can be increased. Further, the third metal layer is laminated on the negative electrode layer without sandwiching other layers, but contains the third metal which is nickel or copper, and thus deterioration or the like is unlikely to occur. As a result, degradation of the battery properties of the battery can be suppressed.

Hereinafter, embodiments of the present disclosure will be described with reference to the accompanying drawings.

Further, all the embodiments described below are comprehensive or specific examples. The numerical values, the shapes, the materials, the constituent elements, the positions of disposition and the forms of connection of the constituent elements, the steps, and the order of the steps described in the following embodiments are merely examples and are not intended to limit the present disclosure. Further, the constituent elements that are not described in the independent claims among the constituent elements in the following embodiments may be described as optional constituent elements.

Further, each drawing is a schematic view and is not necessarily strictly illustrated. Accordingly, for example, the scales and the like in each drawing do not necessarily match each other. Further, the configurations which are substantially the same as each other in each drawing are denoted by the same reference numerals, and repetitive description will be omitted or simplified.

Further, in the present specification and the drawings, an x-axis, a y-axis, and a z-axis denote three axes of a three-dimensional orthogonal coordinate system. The z-axis matches a lamination direction of each layer of the current collector and the battery.

Further, in the present specification, “lamination direction” matches a main surface normal direction of each layer of the current collector and the battery. Further, in the present specification, “plan view” denotes that the main surface of the battery or the current collector is viewed in a direction perpendicular to the main surface when this term is used alone, unless otherwise specified.

Further, in the present specification, “upward” and “downward” are used as the terms defined by a relative positional relationship based on the lamination order in a lamination configuration without indicating the upward direction (vertically upward) and the downward direction (vertically downward) in absolute spatial recognition. Further, the terms “upward” and “downward” are used not only a case where two constituent elements are spaced apart from each other and another constituent element is present between the two constituent elements but also a case where two constituent elements are disposed in close contact with each other and the two constituent elements come into contact with each other. In the description below, the negative side of the z-axis will be referred to as “downward” or “lower side”, and the positive side of the z-axis will be referred to as “upward” or “upper side”.

Further, in the present specification, “%” indicating the proportion or the like of a material is % by weight unless otherwise specified.

### Embodiment 1

In Embodiment 1, a current collector having a lamination structure will be described.

### [Configuration of Current Collector]

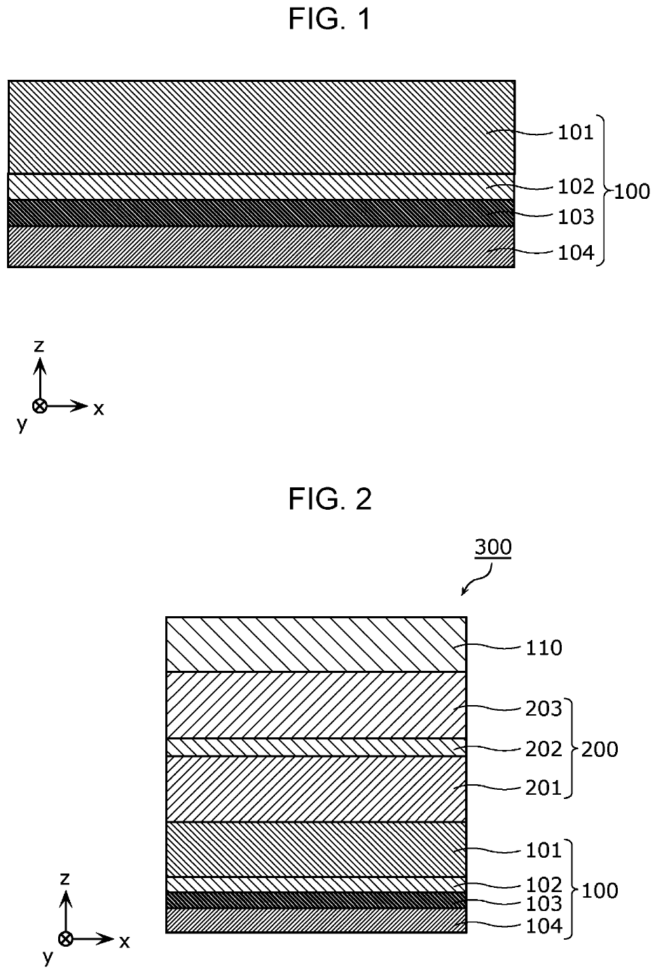

FIG. 1 is a cross-sectional view showing a schematic configuration of a current collector 100 according to the present embodiment.

As shown in FIG. 1, the current collector 100 has a structure in which a first metal layer 101, a conductor layer 102, a second metal layer 103, and a third metal layer 104 are laminated in this order in the z-axis direction from the upper side. The current collector 100 is a laminated current collector obtained by laminating a plurality of layers. Although the details will be described below, the current collector 100 is, for example, a current collector for laminating a positive electrode layer directly on the first metal layer 101. More specifically, when the current collector 100 is used in a battery, for example, the first metal layer 101 is bonded to a positive electrode layer and the third metal layer 104 is bonded to a negative electrode layer. The current collector 100 is, for example, used for connecting power generation elements to be laminated in series.

The current collector 100 has, for example, a sheet shape in which the z-axis direction is the thickness direction. The shape of the current collector 100 in plan view is, for example, rectangular, but is not particularly limited. In the cross-sectional views such as FIG. 1 in the present specification, the thickness of each layer is shown in an exaggerated manner in order to facilitate the understanding of the layer structure of the current collector 100 or the like. Therefore, in each drawing, the ratio between the thicknesses of layers and the like may not match the actual ratio and the like.

Next, the details of each layer of the current collector 100 will be described.

### [1. First Metal Layer]

The first metal layer 101 is a metal current collecting layer to be bonded to a positive electrode layer. The first metal layer 101 is, for example, a metal foil. The first metal layer 101 contains the first metal. The first metal layer 101 contains, for example, the first metal as a main component. In the present specification, the expression “a certain layer contains a certain material as a main component”, such as “the first metal layer 101 contains the first metal as a main component”, denotes that the proportion of “certain material” is the highest in the materials contained in the constituent element of “certain layer” or the like. Further, in the present specification, the proportion of “certain material” in the materials contained in the constituent element of “certain layer” or the like in a case where “a certain layer contains a certain material as a main component” may be greater than or equal to 50%, greater than or equal to 70%, greater than or equal to 90%, or greater than or equal to 95%.

Further, the first metal layer 101 is, for example, formed of the first metal or an alloy containing the first metal. The alloy containing the first metal may contain an element other than a metal element such as carbon. The content of the element other than a metal element in the alloy containing the first metal is, for example, less than or equal to 5%.

The first metal layer 101 may contain a material other than the first metal and the alloy containing the first metal. The proportion of the material other than the first metal and the alloy containing the first metal in the first metal layer 101 is, for example, less than or equal to 5%.

Further, the first metal layer 101 does not contain, for example, the second metal and the third metal described below.

The first metal is, for example, aluminum or iron. In this manner, lithium alloying and elution into the positive electrode layer are unlikely to occur in the first metal layer 101 when the first metal layer 101 is bonded to the positive electrode layer, and thus degradation of the battery properties can be suppressed. In a case where the first metal is iron, examples of the alloy containing the first metal include stainless steel.

The thickness of the first metal layer 101 may be, for example, greater than or equal to 3 μm or greater than or equal to 5 μm. When the thickness of the first metal layer 101 is greater than or equal to 3 μm, the mechanical strength increases, failure such as breakage in the production step and the like is unlikely to occur, and the current collecting function is also likely to be enhanced. Further, the thickness of the first metal layer 101 may be, for example, less than or equal to 50 μm or less than or equal to 20 μm. When the thickness of the first metal layer 101 is less than or equal to 50 μm, the energy density of the battery formed of the current collector 100 can be increased.

### [2. Conductor Layer]

The conductor layer 102 is disposed to face the first metal layer 101. The conductor layer 102 is positioned between the first metal layer 101 and the second metal layer 103. The conductor layer 102 comes into contact with each of the first metal layer 101 and the second metal layer 103. When the conductor layer 102 is not present due to the influence of the wettability of the surface of the first metal layer 101, the contact properties between the first metal layer 101 and the second metal layer 103 are degraded and thus the binding properties are likely to be degraded, but the binding properties between the first metal layer 101 and the second metal layer 103 are improved due to the presence of the conductor layer 102. As a result, since the electric resistance of the current collector 100 can be decreased, the battery properties can be increased.

The conductor layer 102 contains a conductive carbon material. The conductor layer 102 contains, for example, a conductive carbon material as a main component. The conductive carbon material is not particularly limited as long as the carbon material has conductivity. Examples of the conductive carbon material include carbon black such as acetylene black, KETJENBLACK (registered trademark), thermal black, or furnace black, carbon fibers such as carbon nanotubes or carbon nanofibers, activated carbon, graphite, and graphene. The conductor layer 102 may contain only one or two or more kinds of materials from among these conductive carbon materials. Further, the conductor layer 102 may be a non-metal conductor layer containing no metal material.

The thickness of the conductor layer 102 is, for example, greater than or equal to 0.1 μm and less than or equal to 2.0 μm. When the thickness of the conductor layer 102 is greater than or equal to 0.1 μm, the binding properties between the first metal layer 101 and the second metal layer 103 are enhanced, and the electric resistance can be effectively decreased. Further, when the thickness of the conductor layer 102 is less than or equal to 2.0 μm, the energy density of the battery formed of the current collector 100 can be increased.

Further, the conductor layer 102 may further contain a resin. Examples of the resin include polyvinylidene fluoride, polytetrafluoroethylene, polyethylene, polypropylene, an aramid resin, polyamide, polyimide, polyamide imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrenebutadiene rubber, and carboxymethyl cellulose. As the resin, a copolymer of two or more kinds of materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can be used. Further, a curable resin cured by heat or light, such as an epoxy resin or a silicone resin, may be used as the resin. Further, the conductor layer 102 may contain only one or two or more kinds of materials among these resins. In a case where the conductor layer 102 contains a conductive carbon material and a resin, the proportion of the conductive carbon material in the conductor layer 102 is, for example, greater than or equal to 50% and less than or equal to 95%.

A method of forming the conductor layer 102 is not particularly limited, and examples thereof include a method of coating the first metal layer 101 with a paste containing a conductive carbon material and a resin. The method of coating the layer with the paste is not particularly limited, and examples thereof include typical coating methods. Further, the applied paste may be dried as necessary. Further, a curing treatment is performed after the application when the resin is a curable resin. Further, the conductor layer 102 may be formed by film formation of the conductive carbon material on the first metal layer 101 by a spin coating method or the like using a dispersion liquid in which the conductive carbon material is dispersed. Further, the conductor layer 102 may be formed by carbonizing the resin material, such as polyimide, formed on the first metal layer 101.

### [3. Second Metal Layer]

The second metal layer 103 is, for example, a thin metal film formed by vapor deposition or the like. The second metal layer 103 is disposed to face the first metal layer 101 via the conductor layer 102. The second metal layer 103 is positioned between the conductor layer 102 and the third metal layer 104. The second metal layer 103 comes into contact with, for example, each of the conductor layer 102 and the third metal layer 104.

The second metal layer 103 contains the second metal. The second metal layer 103 contains, for example, the second metal as a main component.

Further, the second metal layer 103 does not contain, for example, the first metal and the third metal described below.

The second metal is, for example, a metal different from the first metal. Specifically, the second metal is, for example, chromium or titanium. In this manner, the second metal layer 103 with high hardness is easily formed.

Further, the second metal layer 103 is, for example, formed of the second metal, but may be formed of an alloy containing the second metal. The second metal layer 103 may contain a material other than the second metal and the alloy containing the second metal. The proportion of the material other than the second metal and the alloy containing the second metal in the second metal layer 103 is, for example, less than or equal to 5%.

The thickness of the second metal layer 103 is, for example, greater than or equal to 0.1 μm and less than or equal to 0.5 μm. In a case where the thickness of the second metal layer 103 is greater than or equal to 0.1 μm, the negative electrode layer and the first metal layer 101 are unlikely to come into contact with each other even when pressurized during the formation of the battery, and thus deterioration of the first metal layer 101 can be suppressed. Further, when the thickness of the second metal layer 103 is less than or equal to 0.5 μm, the second metal layer 103 is unlikely to be peeled off. Further, the second metal layer 103 is suppressed from being formed in a scaly shape so that the second metal layer 103 is easily formed to have a uniform thickness.

The second metal layer 103 is formed by film formation on the conductor layer 102 using a vapor deposition method such as a vacuum deposition method. Here, a satisfactory film can be obtained in the formation of the second metal layer 103 due to the presence of the conductor layer 102. Specifically, the metal is likely to be unevenly distributed due to the influence of the wettability when the metal film is formed on the surface of the first metal layer 101, but the second metal layer 103 having a predetermined film thickness can be uniformly formed on the conductor layer 102 due to the presence of the conductor layer 102 between the second metal layer 103 and the first metal layer 101.

Further, for example, the second metal layer 103 is harder than the first metal layer 101 when the hardness of the first metal layer 101 is compared with the hardness of the second metal layer 103. For example, the young's modulus of the second metal layer 103 is greater than the young's modulus of the first metal layer 101.

### [4. Third Metal Layer]

The third metal layer 104 is, for example, a thin metal film formed by vapor deposition or the like. The third metal layer 104 is disposed to face the conductor layer 102 via the second metal layer 103. The third metal layer 104 comes into contact with, for example, the second metal layer 103.

The third metal layer 104 contains the third metal. The third metal layer 104 contains, for example, the third metal as a main component.

Further, the third metal layer 104 does not contain, for example, the first metal and the second metal.

The third metal is a metal different from the first metal and the second metal. Specifically, the third metal is, for example, nickel or copper. In this manner, lithium alloying and elution into the negative electrode layer are unlikely to occur in the third metal layer 104 when the third metal layer 104 is bonded to the negative electrode layer, and thus degradation of the battery properties can be suppressed. Further, the electric resistance of nickel and copper is lower than the electric resistance of other metals, and the battery properties can be improved by decreasing the electric resistance of the current collector 100.

Further, the third metal layer 104 is, formed of the third metal, but may be formed of an alloy containing the third metal. The third metal layer 104 may contain a material other than the third metal and the alloy containing the third metal. The proportion of the material other than the third metal and the alloy containing the third metal in the third metal layer 104 is, for example, less than or equal to 5%.

In this manner, the current collector 100 has a configuration in which the second metal layer 103 and the third metal layer 104 which are formed of metals different from each other are laminated. In this manner, the current collector 100 in which both the suitability of the bonding to the negative electrode layer and the mechanical strength are achieved can be realized by appropriately selecting the second metal and the third metal. Further, when a metal layer is formed by vapor deposition or the like, a metal layer with a more uniform thickness can be formed by forming the second metal layer 103 and the third metal layer 104 as compared with a case where a metal layer having a total thickness of the second metal layer 103 and the third metal layer 104 is formed as a single metal layer.

The thickness of the third metal layer 104 is, for example, greater than or equal to 0.5 μm and less than or equal to 1.5 μm. When the thickness of the third metal layer 104 is greater than or equal to 0.5 μm, the negative electrode layer is unlikely to come into contact with the first metal layer 101, and thus the degradation of the first metal layer 101 can be suppressed. Further, when the thickness of the third metal layer 104 is less than or equal to 1.5 μm, the third metal layer 104 is unlikely to be peeled off. Further, the third metal layer 104 is suppressed from being formed in a scaly shape so that the third metal layer 104 is easily formed to have a uniform thickness. As a result, bonding failure between the third metal layer 104 and the negative electrode layer is unlikely to occur.

Further, the thickness of the third metal layer 104 is, for example, greater than the thickness of the second metal layer 103. In this manner, since the thickness of the third metal layer 104 containing copper or nickel increases, the electric resistance of the current collector 100 is unlikely to increase, and degradation of the battery properties can be suppressed.

Further, the total thickness of the second metal layer 103 and the third metal layer 104 may be less than the thickness of the first metal layer 101. In this manner, the energy density of the battery formed of the current collector 100 can be increased. From the viewpoint of further increasing the energy density of the battery, the total thickness of the conductor layer 102, the second metal layer 103, and the third metal layer 104 may be less than the thickness of the first metal layer 101.

The third metal layer 104 is formed, for example, by film formation on the second metal layer 103 using a vapor deposition method such as a vacuum deposition method. Here, when the second metal layer 103 is a thin metal film formed by vapor deposition or the like, the wettability of the surface of the second metal layer 103 is stabilized, and thus a phenomenon in which the metal is unevenly distributed in the vapor deposition of the third metal layer 104 is unlikely to occur.

Further, for example, the second metal layer 103 is harder than the third metal layer 104 when the hardness of the second metal layer 103 is compared with the hardness of the third metal layer 104. For example, the young's modulus of the second metal layer 103 is greater than the young's modulus of the third metal layer 104. As described above, when the second metal layer 103 is harder than the third metal layer 104, the second metal layer 103 is unlikely to be damaged in a case where each layer of the battery is compressed during the formation of the battery, and the negative electrode layer is unlikely to come into contact with the first metal layer 101. Therefore, since degradation of the battery properties due to deterioration of the first metal layer 101 is suppressed and the pressure of the compression during the formation of the battery can be increased, the energy density of the battery can be improved. Further, the contact resistance between the negative electrode layer and the third metal layer 104 is unlikely to be increased because the third metal layer 104 to be bonded to the negative metal layer is softer than the negative electrode layer. Further, a soft metal tends to have low electric resistance, and thus the electric resistance of the current collector 100 can be decreased.

Further, the current collector 100 is described to be used for connecting power generation elements to be laminated in series, but the current collector may have a structure in which the conductor layer 102, the second metal layer 103, and the third metal layer 104 are laminated on each of the main surfaces on both sides of the first metal layer 101 when the current collector 100 is used for connecting the power generation elements to be laminated in parallel.

### [Method of Producing Current Collector]

Next, a method of producing the current collector 100 will be described. The current collector 100 is produced, for example, in the following manner. Further, the method of producing the current collector 100 is not limited to the following example.

First, a metal foil formed of the first metal or an alloy containing the first metal is prepared as the first metal layer 101. For example, aluminum foil or stainless steel foil is prepared as the metal foil. Further, the conductor layer 102 is formed on the first metal layer 101 by coating one surface of the prepared metal foil with a paste containing a conductive carbon material and a resin as the material of the conductor layer 102.

Next, the second metal layer 103 is formed by film formation of the second metal using a vacuum deposition method on the surface of the conductor layer 102 formed on the first metal layer 101 on a side opposite to the side of the first metal layer 101. Since the conductive carbon material has satisfactory wettability of the metal, the second metal can be formed into a film with a uniform thickness by vapor-depositing the second metal layer 103 on the conductor layer 102.

Next, the third metal layer 104 is formed by film formation of the third metal using a vacuum deposition method, on the surface of the second metal layer 103 formed on the conductor layer 102 on a side opposite to the side of the conductor layer 102. Since the wettability of the surface of the second metal layer 103 serving as a vapor deposition film is stabilized, the third metal is unlikely to be unevenly distributed even in a case where the third metal is vapor-deposited. Further, in a case where a metal layer is formed on the conductor layer 102 with a predetermined thickness such that the negative electrode layer is unlikely to come into contact with the first metal layer 101 during the formation of the battery, when two layers, the second metal layer 103 and the third metal layer 104, are formed, a structure in which peeling or the like of a layer is unlikely to occur even with the same thickness is obtained as compared with a case where one layer is formed.

The current collector 100 is obtained by performing the above-described steps. When the current collector 100 is produced by the above-described method, the current collector 100 capable of suppressing deterioration even in a case of being used to connect power generation elements in series as one current collector can be produced such that uneven distribution or the like of the metals constituting the metal layer does not occur. Therefore, degradation of the battery properties can be further suppressed.

### Embodiment 2

Next, Embodiment 2 will be described. Specifically, in Embodiment 2, a battery formed of the current collector 100 according to Embodiment 1 described above will be described. The battery according to the present embodiment is a battery including one or a plurality of power generation elements.

### [Configuration of Battery]

First, a battery having one power generation element will be described. FIG. 2 is a cross-sectional view showing the schematic configuration of a battery 300 according to the present embodiment.

As shown in FIG. 2, the battery 300 includes the current collector 100, a power generation element 200 having a positive electrode layer 201, a solid electrolyte layer 202, and a negative electrode layer 203, and a current collector 110. The battery 300 is, for example, an all-solid-state battery. The battery 300 has a structure in which the current collector 100, the positive electrode layer 201, the solid electrolyte layer 202, the negative electrode layer 203, and the current collector 110 are laminated in this order from the lower side in the z-axis direction. The current collector 100, the positive electrode layer 201, the solid electrolyte layer 202, the negative electrode layer 203, and the current collector 110 have, for example, the same shape in plan view, and the contours thereof match each other.

The area of the main surface of the battery 300 is, for example, greater than or equal to 1 cm² and less than or equal to 100 m² when the battery is used as a battery for a portable electronic device such as a smartphone or a digital camera. Further, the area of the main surface of the battery 300 may be greater than or equal to 100 cm² and less than or equal to 1000 cm² when the battery is used as a battery for a power supply of large mobile equipment such as an electric vehicle.

The shape of the battery 300 is, for example, a flat rectangular parallelepiped with the shortest length in the lamination direction. The shape of the battery 300 is not particularly limited, and the battery may have another shape such as a cubic shape, a cylindrical shape, a truncated quadrangular shape, a truncated conical shape, or a polygonal prism shape. The shape of the battery 300 in plan view is, for example, a rectangular shape. The shape of the battery 300 in plan view may be another quadrangular shape such as a square shape, a parallelogram, or a rhombus shape, a polygonal shape such as a hexagonal shape or an octagonal shape, a circular shape, or an elliptical shape.

The power generation element 200 is an example of the first power generation element positioned on the current collector 100 and laminated adjacent to the current collector 100. The power generation element 200 is positioned between the current collector 100 and the current collector 110. Further, the battery 300 may include at least one or a plurality of the power generation elements 200. The battery including a plurality of the power generation elements 200 will be described below.

The positive electrode layer 201 is positioned to face the negative electrode layer 203. Further, the positive electrode layer 201 is positioned between the current collector 100 and the solid electrolyte layer 202. The positive electrode layer 201 faces the first metal layer 101 of the current collector 100 without sandwiching the solid electrolyte layer 202 and the conductor layer 102. The positive electrode layer 201 comes into contact with, for example, the first metal layer 101 and the solid electrolyte layer 202. The positive electrode layer 201 is bonded to the first metal layer 101 of the current collector 100. Further, the positive electrode layer 201 may be bonded to the first metal layer 101 via a conductive connection layer or the like containing a conductive carbon material.

The positive electrode layer 201 contains at least a positive electrode active material. The positive electrode layer 201 may be a positive electrode mixture layer containing other materials such as a positive electrode active material and a solid electrolyte.

The positive electrode active material contained in the positive electrode layer 201 is, for example, a material that stores and releases metal ions. The positive electrode active material may be, for example, a material that stores and releases lithium ions. For example, a lithium-containing transition metal oxide, a transition metal fluoride, a polyanion, a fluorinated polyanion material, a transition metal sulfide, a transition metal oxyfluoride, a transition metal oxysulfide, or a transition metal oxynitride can be used as the positive electrode active material contained in the positive electrode layer 201. Particularly, when a lithium-containing transition metal oxide is used as the positive electrode active material, the production cost can be reduced, and the average discharge voltage can be increased. The solid electrolyte used in the positive electrode layer 201 will be described below.

The thickness of the positive electrode layer 201 may be greater than or equal to 10 μm and less than or equal to 500 μm. When the thickness of the positive electrode layer 201 is greater than or equal to 10 μm, the energy density of the battery can be sufficiently ensured. When the thickness of the positive electrode layer 201 is less than or equal to 500 μm, the battery is easily operated at a high output.

The negative electrode layer 203 is disposed to face the positive electrode layer 201. Further, the negative electrode layer 203 is positioned between the current collector 110 and the solid electrolyte layer 202. The negative electrode layer 203 comes into contact with, for example, each of the current collector 110 and the solid electrolyte layer 202. The negative electrode layer 203 is, for example, bonded to the current collector 110. Further, the negative electrode layer 203 may be bonded to the current collector 110 via a conductive connection layer or the like containing a conductive carbon material.

The negative electrode layer 203 contains at least a negative electrode active material. The negative electrode layer 203 may be a negative electrode mixture layer containing other materials such as a negative electrode active material and a solid electrolyte.

The negative electrode active material contained in the negative electrode layer 203 is, for example, a material that stores and releases metal ions. The negative electrode active material may be, for example, a material that stores and releases lithium ions. For example, lithium metal, a metal or an alloy showing an alloying reaction with lithium, a carbon material, a transition metal oxide, or a transition metal sulfide can be used as the negative electrode active material contained in the negative electrode layer 203. For example, graphite or a non-graphite carbon material such as hard carbon or coke is used as the carbon material. For example, CuO, NiO, or the like can be used as the transition metal oxide. For example, copper sulfide represented by CuS can be used as the transition metal sulfide. For example, a silicon compound, a tin compound, or an alloy of an aluminum compound and lithium can be used as a metal or an alloy showing an alloying reaction with lithium. When the carbon material is used, the production cost can be reduced, and the average discharge voltage can be increased. The solid electrolyte used in the negative electrode layer 203 will be described below.

The thickness of the negative electrode layer 203 may be greater than or equal to 10 μm and less than or equal to 500 μm. Further, when the thickness of the negative electrode layer 203 is greater than or equal to 10 μm, the energy density of the battery can be sufficiently ensured. When the thickness of the negative electrode layer 203 is less than or equal to 500 μm, the battery is easily operated at a high output.

At least one of the positive electrode layer 201 or the negative electrode layer 203 may contain a conductive assistant for the purpose of increasing the electronic conductivity. For example, graphite such as natural graphite or artificial graphite, carbon black such as acetylene black or KETJENBLACK, conductive fibers such as carbon fibers or metal fibers, metal powder such as carbon fluoride or aluminum, conductive whiskers such as zinc oxide or potassium titanate, a conductive metal oxide such as titanium oxide, a conductive polymer compound such as polyaniline, polypyrrole, or polythiophene, or the like can be used as the conductive assistant. When a conductive assistant of a carbon material is used, the costs can be reduced.

The solid electrolyte layer 202 is positioned between the positive electrode layer 201 and the negative electrode layer 203. The solid electrolyte layer 202 comes into contact with each of the positive electrode layer 201 and the negative electrode layer 203.

The solid electrolyte layer 202 contains at least a solid electrolyte. The solid electrolyte used in the solid electrolyte layer 202 will be described below.

The thickness of the solid electrolyte layer 202 may be greater than or equal to 1 μm and less than or equal to 200 μm. Further, when the thickness of the solid electrolyte layer 202 is greater than or equal to 1 μm, a short circuit between the positive electrode layer 201 and the negative electrode layer 203 can be suppressed. When the thickness of the solid electrolyte layer 202 is less than or equal to 200 μm, the battery is easily operated at a high output.

As the solid electrolyte contained in the positive electrode layer 201, the negative electrode layer 203, and the solid electrolyte layer 202, for example, a sulfide solid electrolyte, an oxide solid electrolyte, a halide solid electrolyte, a polymeric solid electrolyte, a complex hydride solid electrolyte, or the like can be used. The solid electrolyte has, for example, lithium ionic conductivity.

For example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like can be used as the sulfide solid electrolyte. Further, LiX (X: F, Cl, Br, I), Li₂O, MOₚ, Li_{q}MOᵣ (M is any one of P, Si, Ge, B, Al, Ga, In, Fe, or Zn, and p, q, and r each represent a natural number), and the like may be added thereto.

As the oxide solid electrolyte, for example, LiTi₂(PO₄)₃ and a NASICON type solid electrolyte representing an element substitute thereof, a (LaLi)TiO₃-based perovskite type solid electrolyte, Li₁₄ZnGe₄O₁₆, Li₄SiO₄, LiGeO₄ and a LISICON type solid electrolyte representing an element substitute thereof, Li₇La₃Zr₂O₁₂ and a garnet type solid electrolyte representing an element substitute thereof, Li₃N and an H-substitute thereof, Li₃PO₄, an N-substitute thereof, and glass or glass ceramics to which Li₂SO₄, Li₂CO₃, or the like has been added based on a Li—B—O compound such as LiBO₂ or Li₃BO₃ can be used.

As the halide solid electrolyte, for example, a material represented by Formula Li_{α}M_{β}X_{γ}, in which α, β, and γ represent a value greater than 0, M includes at least one from among metal elements other than Li and metalloid elements, and X represents one or two or more kinds of elements selected from the group consisting of Cl, Br, I, and F, can be used. Here, the metalloid elements include B, Si, Ge, As, Sb, and Te. The metal elements include all elements contained in Group 1 to Group 12 in the periodic table except for hydrogen and all elements contained in Group 13 to Group 16 except for the metalloid elements, C, N, P, O, S, and Se. That is, the metal elements are a group of elements that can be cations when a halogen compound and an inorganic compound are formed. As the halide solid electrolyte, Li₃YX₆, Li₂MgX₄, Li₂FeX₄, Li(Al,Ga,In)X₄, Li₃(Al,Ga,In)X₆, or the like (X represents any one of F, Cl, Br, or I) can be used.

As the complex hydride solid electrolyte, for example, LiBH₄—LiI or LiBH₄—P₂S₅ can be used.

For example, a compound of a polymer compound with a lithium salt can be used as the polymeric solid electrolyte. The polymer compound may have an ethylene oxide structure. When the polymer compound has an ethylene oxide structure, the polymer compound can contain a large amount of lithium salts, and the ionic conductivity can be further increased. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One type of lithium salt selected from these can be used alone as the lithium salt. Alternatively, a mixture of two or more kinds of lithium salts selected from these can be used as the lithium salt.

At least one of the positive electrode layer 201, the solid electrolyte layer 202, or the negative electrode layer 203 may contain a binder for the purpose of improving the adhesiveness between the particles. The binder is used for improving the binding properties of the material constituting an electrode. Examples of the binder include polyvinylidene fluoride, polytetrafluoroethylene, polyethylene, polypropylene, an aramid resin, polyamide, polyimide, polyamide imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. Further, a copolymer of two or more kinds of materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can be used as the binder. Further, two or more kinds of materials selected from these may be mixed and used as the binder.

The current collector 100 is laminated on a side of the positive electrode layer 201 of the power generation element 200 such that the current collector 100 is adjacent to the power generation element 200. Specifically, the first metal layer 101 of the current collector 100 faces the positive electrode layer 201 of the power generation element 200 without sandwiching the solid electrolyte layer 202 of the power generation element 200 and the conductor layer 102 of the current collector 100. The first metal layer 101 is, for example, in contact with the positive electrode layer 201. The first metal layer 101 faces the negative electrode layer 203 of the power generation element 200 via the positive electrode layer 201 and the solid electrolyte layer 202 and is not in contact with the negative electrode layer 203. As described above, since the first metal layer 101 contains the first metal different from the third metal, which is nickel or copper, deterioration or the like is unlikely to occur even when the first metal layer 101 is bonded to the positive electrode layer 201. Therefore, degradation of the battery properties of the battery 300 formed of the current collector 100 can be suppressed.

Further, since the first metal layer 101 of the current collector 100 is bonded to the positive electrode layer 201, the third metal layer 104 of the current collector 100 is exposed at the bottom of the battery 300 and can be bonded to another power generation element. Further, since the third metal layer 104 contains the third metal, which is nickel or copper, deterioration is unlikely to occur when the third metal layer 104 is bonded to the negative electrode layer. Therefore, the battery 300 is bonded to the negative electrode layer without sandwiching another current collector, and thus the battery properties are unlikely to be degraded even when the battery 300 is electrically connected to another power generation element in series. Accordingly, the energy density can be increased by decreasing the number of current collectors to be used when the battery 300 and other power generation elements are electrically connected in series.

The current collector 110 is laminated on a side of the negative electrode layer 203 of the power generation element 200 such that the current collector 110 is adjacent to the power generation element 200. Specifically, the current collector 110 faces the negative electrode layer 203 of the power generation element 200 without sandwiching the solid electrolyte layer 202 of the power generation element 200. The current collector 110 is, for example, in contact with the negative electrode layer 203. In the present embodiment, the current collector 110 is a negative electrode current collector that exchanges electrons with the negative electrode layer 203.

A known material for a negative electrode current collector can be used as the material for the current collector 110. The current collector 110 is a metal foil formed of copper, nickel, or iron, or an alloy containing at least one of copper, nickel, or iron. The current collector 110 is, for example, a current collector different from the current collector 100, having no lamination structure, and formed of one sheet of metal foil.

The thickness of the current collector 110 is, for example, greater than or equal to 3 μm and less than or equal to 50 μm.

Further, the battery 300 may include the current collector 100 in place of the current collector 110. That is, the power generation element 200 may be positioned between two current collectors 100. In this case, the power generation element 200 and the current collector 100 are laminated such that the third metal layer 104 of the current collector 100 is bonded to the negative electrode layer 203.

The battery 300 may be accommodated in an outer packaging for the purpose of protecting the power generation element 200. The outer packaging may be a resin laminate metal foil in which a resin film is provided on one surface or both surfaces of the metal foil. Specific examples of the outer packaging include a resin laminated metal foil formed by laminating a resin film on one surface of the metal foil in order to impart the mechanical strength and laminating a resin film having heat-sealing properties on the other surface of the metal foil.

The metal foil in the resin laminated metal foil may be, for example, a foil formed of aluminum, an aluminum alloy, or the like. The resin film for maintaining the mechanical strength may be, for example, a film formed of polyester, nylon, or the like. The resin film having heat-sealing properties may be, for example, a film formed of polyolefin, and specifically, the resin film may be, for example, a film formed of polyethylene or polypropylene.

The laminated film constituting the outer packaging may be formed such that one surface or both surfaces thereof are subjected to embossing.

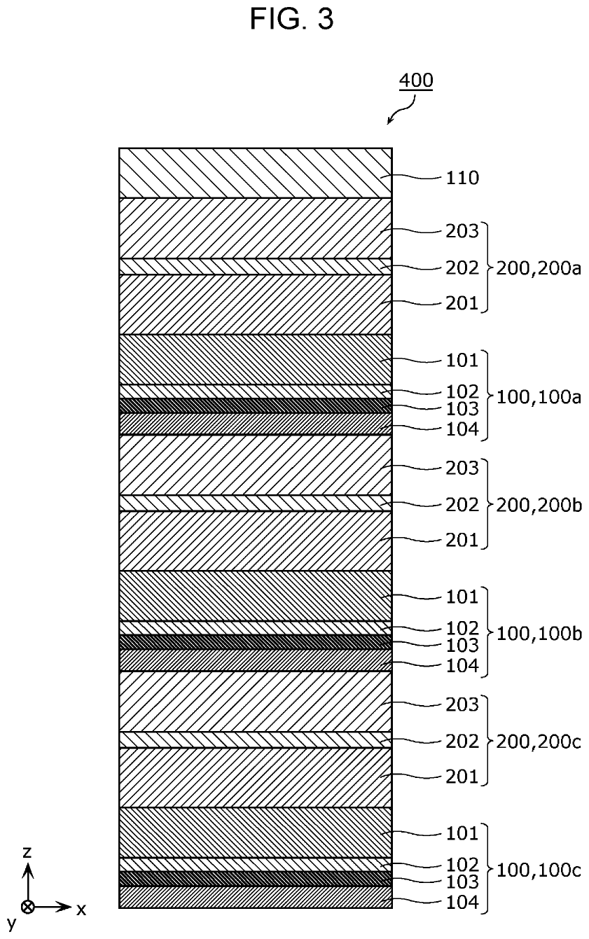

Next, a battery including a plurality of power generation elements will be described. FIG. 3 is a cross-sectional view showing the schematic configuration of a battery 400 according to the present embodiment. In the description of the battery 400 below, different points from the battery 300 will be mainly described, and the description of the common points will be omitted or simplified.

As shown in FIG. 3, the battery 400 includes a plurality of the current collectors 100, a plurality of the power generation elements 200, and the current collector 110. The battery 400 is configured such that the current collector 100 and the power generation element 200 are further laminated on the battery 300. Further, in the description below, a plurality of the power generation elements 200 included in the battery 400 are also shown by being separated to a power generation element 200a, a power generation element 200b, and a power generation element 200c in order from the upper side. Further, a plurality of the current collectors 100 included in the battery 400 are also shown by being separated to a current collector 100a, a current collector 100b, and a current collector 100c in order from the upper side. The power generation element 200a is an example of the first power generation element, and the power generation element 200b is an example of the second power generation element laminated adjacent to the first power generation element via the current collector 100a.

The current collector 100 is disposed between the power generation elements 200 adjacent to each other. In the battery 400, the current collector 100a and the current collector 100b among a plurality of current collectors 100 are positioned between the power generation elements 200 adjacent to each other. Specifically, the current collector 100a is positioned between the power generation element 200a and the power generation element 200b adjacent to each other, and the current collector 100b is positioned between the power generation element 200b and the power generation element 200c adjacent to each other. Further, the current collector 100c is positioned below the power generation element 200c that is positioned on the lowest side of the plurality of the power generation elements 200.

Further, as the current collector positioned on each of the uppermost portion and the lowermost portion of the battery 400, the current collector 100 having a lamination structure or a current collector formed of a metal foil or the like having no lamination structure may be used. For example, the current collector 100 may be disposed in place of the current collector 110 positioned on the uppermost portion of the battery, and a current collector formed of a metal foil such as aluminum foil may be disposed in place of the current collector 100c positioned on the lowermost portion of the battery.

A plurality of the power generation elements 200 are laminated such that the lamination orders from the upper side thereof are the same as each other. Therefore, the plurality of the power generation elements 200 are connected to each other via the current collector 100 and thus the power generation elements 200 are electrically connected to each other in series. In this manner, the voltage of the battery 400 can be increased. Further, since the current collector 100 is commonly disposed between the power generation elements 200 adjacent to each other, the number of current collectors used in the battery 400 can be reduced. As a result, improvement of the energy density due to the reduction of the number of current collectors that do not contribute to power generation and suppression of degradation of the battery properties due to unnecessity of the connection between current collectors can be realized.

The number of the plurality of power generation elements 200 in the battery 400 is 3, but is not particularly limited, and may be 2 or 4 or greater. The voltage of the battery can be increased as the number of the plurality of power generation elements 200 increases. The number of the power generation elements 200 can be optionally set by considering the handleability during the production of the batteries, the loading space of equipment that uses the batteries, the control voltage of equipment that uses the batteries, and the like. For example, more than or equal to 2 and less than or equal to 500 power generation elements 200 may be electrically connected in series.

Each positional relationship between the current collector 100a and the power generation element 200a, the current collector 100b and the power generation element 200b, and the current collector 100c and the power generation element 200c is the same as the positional relationship between the current collector 100 and the power generation element 200 in the battery 300 described above.

The third metal layer 104 of the current collector 100a faces the negative electrode layer 203 of the power generation element 200b without sandwiching the solid electrolyte layer 202 of the power generation element 200b and the second metal layer 103 of the current collector 100a. The third metal layer 104 of the current collector 100a comes into contact with, for example, the negative electrode layer 203 of the power generation element 200b. The negative electrode layer 203 of the power generation element 200b is, for example, bonded to the third metal layer 104 of the current collector 100a. Further, the negative electrode layer 203 of the power generation element 200b may be bonded to the third metal layer 104 of the current collector 100a via a conductive connection layer or the like containing a conductive carbon material.

As described above, since the third metal layer 104 contains the third metal, which is nickel or copper, deterioration or the like is unlikely to occur even when the third metal layer 104 is bonded to the negative electrode layer 203. Therefore, degradation of the battery properties of the battery 400 formed of the current collector 100 can be suppressed. Further, the same applies to the current collector 100b and the power generation element 200c.

As described above, the power generation element 200a and the power generation element 200b adjacent to each other are laminated via the current collector 100a in the battery 400. Further, the positive electrode layer 201 of the power generation element 200a and the first metal layer 101 of the current collector 100a are disposed to be adjacent to each other, and the negative electrode layer 203 of the power generation element 200b and the third metal layer 104 of the current collector 100a are disposed to be adjacent to each other. In this manner, the power generation element 200a and the power generation element 200b are electrically connected in series. As described above, the power generation element 200a and the power generation element 200b are laminated via one sheet of the current collector 100a, and thus a battery with a high energy density can be realized by reducing the number of current collectors to be used. Further, the first metal layer 101 of the current collector 100a is laminated on the positive electrode layer 201 of the power generation element 200a without sandwiching other layers, but contains the first metal different from the third metal, which is nickel or copper, and accordingly, deterioration or the like is unlikely to occur. Further, the third metal layer 104 of the current collector 100a is laminated on the negative electrode layer 203 of the power generation element 200b without sandwiching other layers, but contains the third metal, which is nickel or copper, and accordingly, deterioration or the like is unlikely to occur. Therefore, degradation of the battery properties of the battery 400 formed of the current collector 100a can be suppressed.

### [Method of Producing Battery]

Next, a method of producing the battery 300 and the battery 400 will be described. The battery 300 and the battery 400 are produced, for example, in the following manner. Further, the method of producing the battery 300 and the battery 400 is not limited to the following example.

First, the positive electrode layer 201 is formed on the current collector 100. Specifically, a slurry is prepared by mixing a positive electrode active material, a solvent, and as necessary, at least one of a solid electrolyte, a binder, or a conductive assistant. Further, the surface of the first metal layer 101 of the current collector 100 on the side opposite to the side of the conductor layer 102 is die-coated with the prepared slurry. The coating method is not particularly limited, and a typical coating method can be used. Thereafter, the positive electrode layer 201 with a predetermined thickness and a predetermined shape can be obtained by drying the slurry. Further, the positive electrode layer 201 may be pressurized as necessary after the drying.

Next, the solid electrolyte layer 202 is formed on the positive electrode layer 201 formed above. Specifically, a slurry is prepared by mixing a solid electrolyte, a solvent, and as necessary, a binder. Further, the surface of the positive electrode layer 201 formed above on the side opposite to the side of the current collector 100 is die-coated with the prepared slurry. The coating method in this case is not particularly limited, and a typical coating method can be used. Thereafter, the solid electrolyte layer 202 with a predetermined thickness can be obtained by drying the slurry. Further, the solid electrolyte layer 202 may be pressurized as necessary after the drying.

Next, the negative electrode layer 203 is formed on the solid electrolyte layer 202 formed above. Specifically, a slurry is prepared by mixing a negative electrode active material, a solvent, and as necessary, at least one of a solid electrolyte, a binder, and a conductive assistant. Further, the surface of the solid electrolyte layer 202 formed above on the side opposite to the side of the positive electrode layer 201 is die-coated with the prepared slurry. The coating method in this case is not particularly limited, and a typical coating method can be used. Thereafter, the negative electrode layer 203 with a predetermined thickness can be obtained by drying the slurry. Further, the negative electrode layer 203 may be pressurized as necessary after the drying.

A laminated plate in which the power generation element 200 is laminated on the current collector 100 is obtained by performing the above-described steps. The obtained laminated plate may be cut into predetermined dimensions as necessary. The cutting method is not particularly limited, and a typical cutting method such as shearing using a knife can be used.

The number of the laminated plates to be prepared is set according to the number of the power generation elements 200 intended to be connected. The number of the laminated plates to be prepared is not particularly limited, but is, for example, 1 in a case of the battery 300 and 3 in a case of the battery 400.

Next, when the battery 400 is prepared, the required number of the prepared laminated plates are laminated such that the power generation elements 200 are electrically connected in series. That is, a plurality of the laminated plates are laminated such that the third metal layer 104 of the current collector 100 on one side and the negative electrode layer 203 of the power generation element 200 on the other side in the adjacent laminated plates face each other. Further, the battery 400 is obtained by disposing the current collector 110 on the negative electrode layer 203 on the uppermost portion of the battery. Here, the obtained battery 400 may be pressurized as necessary. Further, electricity extraction terminals from the upper surface and the lower surface of the battery 400 may be connected to each other as necessary, or the obtained battery 400 may be accommodated in the outer packaging. The shape and the like of the extraction terminal and the outer packaging are not particularly limited. The battery 300 is produced by disposing the current collector 110 on the negative electrode layer 203 of one laminated plate without laminating the laminated plates in the above-described method.

### Other Embodiments

Hereinbefore, the battery according to the present disclosure has been described based on the embodiments, but the present disclosure is not limited thereto. The scope of the present disclosure includes various modifications of the embodiments that can be conceived by those skilled in the art and other aspects constructed by combining some constituent elements in the embodiments, within a range not departing from the gist of the present disclosure.

For example, in the above-described embodiment, the current collector 100 includes the first metal layer 101, the conductor layer 102, the second metal layer 103, and the third metal layer 104, but the configuration thereof is not limited thereto. The current collector 100 may include layers other than the first metal layer 101, the conductor layer 102, the second metal layer 103, and the third metal layer 104. For example, another metal layer or another conductor layer may be present between any two adjacent layers from among the first metal layer 101, the conductor layer 102, the second metal layer 103, and the third metal layer 104.

Further, for example, in the battery 300 of the above-described embodiment, the first metal layer 101 of the current collector 100 faces the positive electrode layer 201 of the power generation element 200 without sandwiching the solid electrolyte layer 202 of the power generation element 200 and the conductor layer 102 of the current collector 100, but the configuration thereof is not limited. The third metal layer 104 of the current collector 100 may face the negative electrode layer 203 of the power generation element 200 without sandwiching the solid electrolyte layer 202 of the power generation element 200 and the second metal layer 103 of the current collector 100. For example, the current collector 100 and the power generation element 200 may be laminated such that the third metal layer 104 comes into contact with the negative electrode layer 203. Even in this case, deterioration of the current collector 100 is suppressed because the third metal layer 104 containing nickel or copper is bonded to the negative electrode layer 203. Further, the battery properties of the battery 300 are unlikely to be degraded even when the first metal layer 101 of the current collector 100 is bonded to a positive electrode layer of another power generation element without sandwiching another current collector.

Further, for example, in the battery 400 of the above-described embodiment, all the power generation elements 200 are electrically connected in series, but the configuration is not limited thereto. For example, the batteries 400 may be laminated such that the lamination orders of the layers are set to be opposite, and the power generation elements 200 that have been connected in series may be further connected in parallel. Further, various changes, replacements, additions, omissions, and the like can be made in the embodiments and modification examples described above within the scope of the appended claims and equivalents thereof.

The current collector and the battery according to the present disclosure can be applied to, for example, various batteries such as all-solid-state lithium secondary batteries.

What is claimed is:

1. A current collector comprising:
a first metal layer that contains a first metal;
a conductor layer that contains a conductive carbon material;
a second metal layer that contains a second metal; and
a third metal layer that contains a third metal different from the first metal and the second metal,
wherein the first metal layer, the conductor layer, the second metal layer, and the third metal layer are laminated in this order, and
the third metal is nickel or copper.

2. The current collector according to claim 1,
wherein the first metal is aluminum or iron.

3. The current collector according to claim 1,
wherein the second metal is titanium or chromium.

4. The current collector according to claim 1,
wherein the second metal layer is harder than the third metal layer.

5. The current collector according to claim 1,
wherein a total thickness of the second metal layer and the third metal layer is less than a thickness of the first metal layer.

6. The current collector according to claim 1,
wherein a thickness of the third metal layer is greater than a thickness of the second metal layer.

7. The current collector according to claim 1,
wherein a thickness of the first metal layer is greater than or equal to 3 μm and less than or equal to 50 μm.

8. The current collector according to claim 1,
wherein a thickness of the second metal layer is greater than or equal to 0.1 μm and less than or equal to 0.5 μm.

9. The current collector according to claim 1,
wherein a thickness of the third metal layer is greater than or equal to 0.5 μm and less than or equal to 1.5 μm.

10. The current collector according to claim 1,
wherein a thickness of the conductor layer is greater than or equal to 0.1 μm and less than or equal to 2.0 μm.

11. A battery comprising:
the current collector according to claim 1; and
at least one power generation element that includes a positive electrode layer, a negative electrode layer disposed to face the positive electrode layer, and a solid electrolyte layer positioned between the positive electrode layer and the negative electrode layer,
wherein the at least one power generation element includes a first power generation element to be laminated adjacent to the current collector, and
the first metal layer of the current collector faces the positive electrode layer of the first power generation element without sandwiching the solid electrolyte layer of the first power generation element and the conductor layer of the current collector.

12. The battery according to claim 11,
wherein the at least one power generation element further includes a second power generation element to be laminated adjacent to the first power generation element via the current collector, and
the third metal layer of the current collector faces the negative electrode layer of the second power generation element without sandwiching the solid electrolyte layer of the second power generation element and the second metal layer of the current collector.
